(19) United States
(12) Patent Application Publication
(10) Pub. No.: US 2012/0137874 A1
(43) Pub. Date: Jun. 7, 2012

(54) Structural Unit Comprising a Pump Housing and a Control Unit Housing, and Method for Producing a Structural Unit of this Type

(75) Inventor: Andreas Weh, Sulzberg (DE)

(73) Assignee: Robert Bosch GmbH, Stuttgart (DE)

(21) Appl. No.: 13/305,730

(22) Filed: Nov. 28, 2011

(30) Foreign Application Priority Data
Dec. 1, 2010 (DE) 10 2010 062 265.6

(51) Int. Cl. F04B 53/16; B23P 15/00

(52) U.S. Cl. 92/161; 29/888.02

(57) ABSTRACT

A structural unit includes a pump housing and a control unit housing which are connected to one another. In order to connect the pump housing to the control unit housing, the pump housing has at least one opening with an undercut and the control unit housing has at least one latching lug which is latched on the undercut.

This application claims priority under 35 U.S.C. §119 to patent application no. DE 10 2010 062 265.6, filed on Dec. 1, 2010 in Germany, the disclosure of which is incorporated herein by reference in its entirety.

### BACKGROUND

The disclosure relates to a structural unit comprising a pump housing and a control unit housing which are connected to one another, and to a method for producing a structural unit of this type.

In vehicle brake systems, a distinction can be made between hydraulic systems, in which a control unit is situated directly on a hydraulic assembly, and hydraulic systems with a separate arrangement of said components. In systems, in which the control unit is situated directly on the hydraulic assembly, the control unit housing is fastened to the pump housing of the hydraulic assembly. The fastening is usually realized by means of bushes which are molded into the corner regions of the control unit housing. Screws which are screwed into the pump housing are guided through the bushes. To this end, threaded holes are to be formed in the pump housing. A fastening of this type is also known, for example, from DE 199 16 985 A1.

A further fastening is known, for example, from DE 10 2006 005 215 A1. There, bolt-like pins which reach through bushes are used as fastening means.

It is an object of the present disclosure to provide a structural unit having a pump housing and a control unit housing, in which structural unit a fastening which is simple to produce and is at the same time robust is realized between the pump housing and the control unit housing.

### SUMMARY

According to the disclosure, a structural unit having a pump housing and a control unit housing is provided, in which structural unit the pump housing and the control unit housing are connected to one another in the mounted state, and the connection of the pump housing to the control unit housing is configured by means of at least one opening, in particular a blind hole, in the pump housing, which opening is provided with an undercut, in particular in the form of a constriction. At least one latching lug, in particular two latching lugs which lie opposite one another, is/are latched, hooked or engaged on the undercut, which latching lug is formed on the control unit housing.

The undercut is advantageously formed by means of a perforated disk which is welded or adhesively bonded to the pump housing. The perforated disk can be connected to the pump housing, in particular, via rotary friction welding or ultrasonic welding.

As an alternative, the undercut is preferably produced from the material of the pump housing itself by means of deformation with a tool, by a bead being formed on said pump housing. To this end, the at least one opening for latching the at least one latching lug, which opening has been made in the pump housing, is preferably deformed by means of a tool, in particular a die. As a result of this deformation, material of the pump housing is displaced into the opening and the undercut is produced. The latter can therefore be produced more simply than by way of a production method with the removal of material. In addition, no additional components are required for the undercut.

A setting wet seal is preferably arranged between the pump housing and the control unit housing. A setting wet seal of this type is applied in the viscous state and sets subsequently in a comparatively short time. The sealing region can be defined outside the stated connection by way of the procedure according to the disclosure. This makes a homogeneous profile of the sealing lines possible with few curves.

The at least one latching lug is preferably of conical design in its front region which faces the pump housing. It is preferably molded onto the control unit housing. The design with a conically formed insertion lug of this type ensures that, as resilient elements, the latching lugs have a low force increase gradient during the mounting of the control unit housing. In addition, an orientation of the control unit housing is made possible via the latching lugs of conical configuration. There can be up to six latching lugs per opening.

The latching lugs are preferably of radially resilient configuration relative to the opening. As a result of the clearance which exists between them in the axial direction, said resilient elements are suited well to compensate for positional tolerances between the openings and the latching lugs. The latching lugs are placed with the control unit housing onto the pump housing which forms the hydraulic part, and are subsequently pressed in there. Here, the resilient elements of the latching lugs are pushed together radially by the pressure which acts on them axially. Afterward, the resilient elements of the latching lugs move apart again when they have overcome the bead which is formed at the openings of the pump housing.

According to the disclosure, however, the resilient elements of the latching lugs do not move back into their original position completely. A prestressing force is therefore maintained between the control unit housing and the pump housing in the axial direction. Said prestressing force is advantageously to be maintained at least until the setting of the setting seal or the sealing adhesive.

In the mounted state, the connecting element which is formed with the latching lugs therefore interacts with at least one part of the pump housing and thus connects the control unit housing to the pump housing.

As has already been mentioned, the structural unit which is produced according to the disclosure is preferably a regulating device of a vehicle brake system, in particular a hydraulic assembly. Piston pumps, solenoid valves, hydraulic accumulators, damper chambers and hydraulic components of the like are used and connected hydraulically to one another in the hydraulic assembly in a known way. The control unit comprises an electronic regulating circuit which actuates the piston pumps, the electric motor connected to the latter, and the solenoid valves.

The number of parts of the hydraulic assembly is reduced by way of the connection according to the disclosure; for example, the previously required bushes and screws are dispensed with. Furthermore, there is more design freedom for the design of the printed circuit board within the control unit housing. Thus, a reduction in the size of the printed circuit board of the control unit housing as a result of previously used connecting elements can be avoided. The hydraulic area is independent of the required printed circuit board area.

Otherwise, the features of the disclosure can also be used in any other desired hydraulic systems.

### BRIEF DESCRIPTION OF THE DRAWINGS

In the following text, one exemplary embodiment of the solution according to the disclosure will be explained using the appended diagrammatic drawings, in which:

FIG. 1 shows a part of a pump housing in section, in a first production step with a blind hole,

FIG. 2 shows the view according to FIG. 1 in a second production step with the blind hole, into which a die is pressed,

FIG. 3 shows the view according to FIG. 2 in a third production step with the blind hole with a constriction and a seal,

FIG. 4 shows the view according to FIG. 3 in a fourth production step with the blind hole and a control unit housing with latching lugs,

FIG. 5 shows the view according to FIG. 4 in a fifth production step with the blind hole and the control unit housing with compressed latching lugs, and

FIG. 6 shows the view according to FIG. 5 in a sixth production step with the blind hole and the control unit housing with latching lugs which are latched behind the constriction.

### DETAILED DESCRIPTION

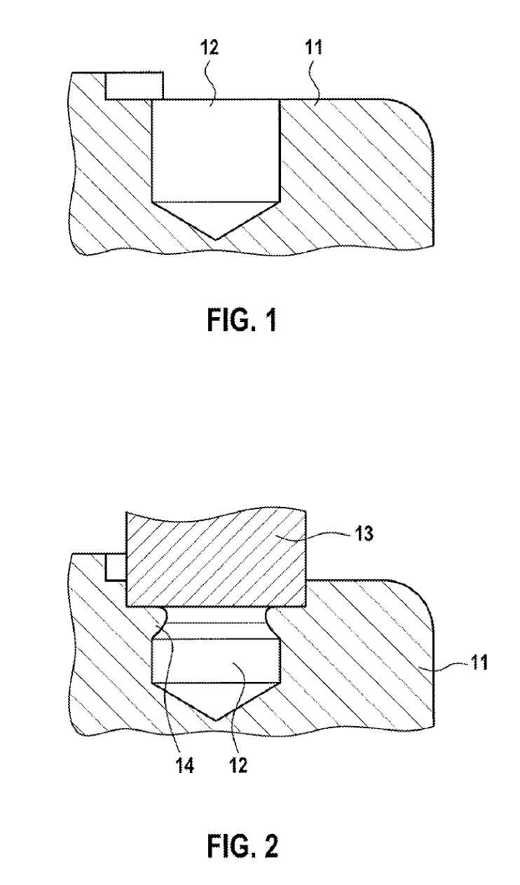

FIG. 1 shows a part of a pump housing 11 which forms one component of a structural unit comprising a pump housing and a control unit housing. The pump housing 11 serves as regulating unit for a vehicle brake system (not shown in greater detail). In order to produce the structural unit, in a first step, an opening 12 in the form of a blind hole is made in the pump housing 11 by means of a drill. Said opening 12 is to serve subsequently for attaching a control unit housing.

FIG. 2 shows how, in a second step, a tool with a die 13 which has a greater diameter than the opening 12 is pressed into the opening 12. This brings about a deformation of the outer edge region of the opening 12 which serves as attaching hole. Here, a bead is produced at the opening 12. A constriction or indentation which acts as an undercut 14 is therefore produced by the displacement of the material of the bead.

An alternative second step which is not shown in greater detail is the attachment of a perforated disk on the pump housing 11 concentrically with respect to the opening 12, by means of welding, in particular by means of rotary friction welding or ultrasonic welding, or adhesive bonding. Here, a hole in the perforated disk has a smaller diameter than the diameter of the opening 12. This likewise produces an undercut 14.

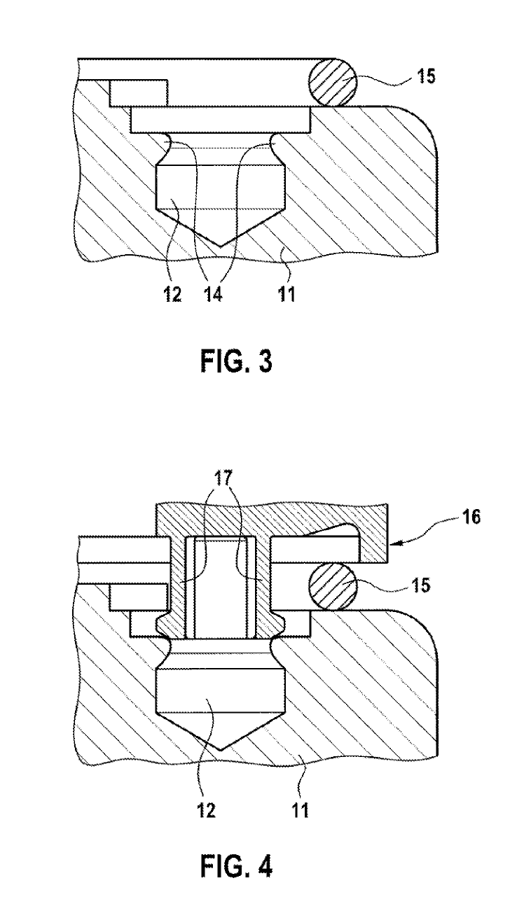

FIG. 3 shows the pump housing 11 with the opening 12 in the form of a blind hole and the introduced undercut 14. In a further step, a seal 15 is arranged on the pump housing 11. The sealing region is therefore defined outside the connection. This makes a homogeneous profile of the sealing line possible. The seal 15 itself is what is known as a wet seal which is first of all applied in the viscous state and subsequently sets.

In addition to the pump housing 11 with the opening 12 and the seal 15, FIG. 4 shows a control unit housing 16. Latching lugs 17 are molded onto the control unit housing 16 by way of an injection molding process. Depending on the embodiment, there are between two and six latching lugs 17 which are of radially resilient configuration. In this illustration, the latching lugs 17 are placed onto the pump housing 1. Centering of the control unit housing 16 on the associated opening 12 is achieved by way of the latching lugs 17 of this type.

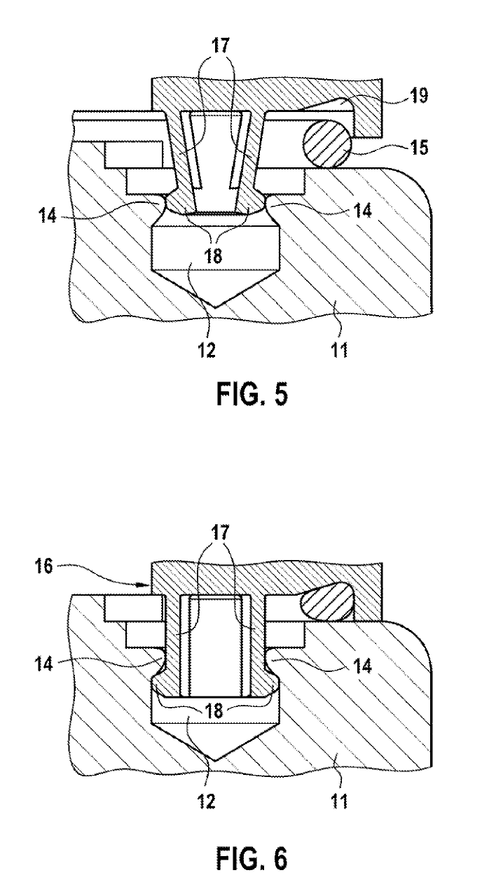

In a further step, as shown in FIG. 5, the latching lugs 17 of the control unit housing 16 are introduced into the opening 12 of the pump housing 11. Here, the latching lugs 17 are compressed by the undercut 14 under axial pressure. Here, the resilient latching lugs 17 move together radially. In order to facilitate the compression, the latching lugs 17 are of conical configuration in the front region 18 which faces the pump housing 11 and faces away from the control unit housing 16. The conical configuration of the front region 18 makes easier orientation of the control unit housing 16 with respect to the pump housing 11 possible. In other words, the conical insertion lug of the latching lug 17 ensures that the resiliently configured parts of the latching lugs 17 have a low force increase gradient during the mounting. Positional tolerances between the openings 12 and the latching lugs 17 can be compensated for by the clearance and/or the axial gaps between the latching lugs 17.

The control unit housing 16 additionally has a recess 19 for receiving the seal 15.

FIG. 6 shows the structural unit with the pump housing 11 and the control unit housing 16, in which structural unit the latching lugs 17 which are molded onto the control unit housing 16 are latched in the opening 12 on the undercut 14. After the bead which is formed in the pump housing 11 has been overcome, the resiliently configured latching lugs 17 namely move apart again as a result of the reduction of the axial pressure. Here, however, the latching lugs 17 no longer move back into their initial position completely and, as a result, maintain a prestressing force in the axial direction between the pump housing 11 and the control unit housing 16. Said prestressing force is maintained at least until setting of the sealing adhesive of the seal 15.

What is claimed is:

1. A structural unit, comprising:
a pump housing; and
a control unit housing,
wherein the pump housing has at least one opening that defines an undercut, and
wherein the control unit housing has at least one latching lug which is latched on the undercut so as to connect the pump housing to the control unit housing.

2. The structural unit according to claim 1, wherein the undercut is formed in the shape of a bead from material of the pump housing.

3. The structural unit according to claim 1, further comprising a setting wet seal disposed between the pump housing and the control unit housing.

4. The structural unit according to claim 1, wherein the at least one latching lug is of conical configuration in a front region which faces the pump housing.

5. The structural unit according to claim 1, wherein the at least one latching lug is molded onto the control unit housing.

6. A method for producing a structural unit that includes a pump housing and a control unit housing, comprising:
(a) forming at least one opening in the pump housing so that the opening is provided with an undercut;
(b) forming at least one latching lug on the control unit housing; and
(c) latching the at least one latching lug on the undercut so as to connect the pump housing to the control unit housing.

7. The method according to claim 6, wherein step (a) includes forming the undercut to be configured as a bead by deformation of material of the pump housing.

8. The method according to claim 6, further comprising locating a setting wet seal between the pump housing and the control unit housing.

9. The method according to claim 6, wherein the at least one latching lug is of conical configuration in a front region which faces the pump housing.

10. The method according to claim 6, wherein step (b) includes molding the at least one latching lug onto the control unit housing.
